(19) United States
(12) Patent Application Publication
(10) Pub. No.: US 2004/0020271 A1
(43) Pub. Date: Feb. 5, 2004

(54) Contaminant containment system in a fueling environment

(76) Inventor: Ray J. Hutchinson, Houma, LA (US)

Correspondence Address: WITHROW & TERRANOVA, P.L.L.C., P.O. BOX 1287, CARY, NC, 27512, US

(21) Appl. No.: 10/209,962

(22) Filed: Jul. 31, 2002

(51) Int. Cl. G01N 11/00

(52) U.S. Cl. 73/53.01

(57) ABSTRACT

A fueling environment includes a contaminant collection chamber positioned in an underground fuel storage tank. Sumps in the fuel dispensers and low point sumps in the piping network drain captured fuel and contaminants to the contaminant chamber by methods such as gravity. A float sensor monitors levels within the contaminant chamber for detecting leaks and/or scheduling service calls. An oil-water separator may be used to economize the use of the contaminant chamber. Further, the underground storage tank may be positioned in various locations in the fueling environment and accommodate a plurality of different types of fuels.

### FIELD OF THE INVENTION

The present invention relates to a contaminant containment system in a fueling environment to reduce the frequency of service calls.

### BACKGROUND OF THE INVENTION

Fueling environments at service stations are concerned with leaks and contaminants for obvious reasons. The fuel that will eventually be dispensed by fuel dispensers into a vehicle is stored underneath the ground in underground storage tanks. Fuel leaks may damage the environment and cause regulatory fines. In most instances, the fueling environments may have multiple locations where fuel leaks may be caught so that these leaks do not run into the ground thereby causing contamination.

One of the most common locations where leaked fuel is captured is in a sump associated with each fuel dispenser. Additionally, a fueling environment may have low point sumps associated with the underground piping network that extends from an underground fuel storage tank to the fuel dispensers. The sumps are usually of small capacity and are not designed to hold large amounts of leaked fuel.

In addition to leaked fuel, contaminants, such as water from rainfall, also seep into the sumps thereby contaminating the fuel. Because of this contamination, the captured fuel from leaks cannot be reused or recycled. However, the presence of the petroleum products precludes simply disposing the fluid into the ground. Service calls may be arranged to clean out the sumps.

Because these sumps are not designed to hold much fuel, service calls must be periodically made to service stations to empty these sumps and dispose of the leaked fuel and contaminants since it cannot be reused without processing. These service calls are frequent, causing the service station owner a great deal of expense. In addition, while the sumps are being cleaned out, components of the service station may be inoperable, causing the service station owner lost revenue opportunities.

Thus, a need exists to consolidate contaminants within a fueling environment in such a manner so as to minimize service calls. Further, any solution should not overly enlarge the footprint of the fueling environment or add to the excavation required to construct the fueling environment.

### SUMMARY OF THE INVENTION

The present invention partitions an underground fuel storage tank into a contaminant chamber and a fuel storage section. The contaminant chamber is fluidly connected to the sumps in the fuel dispensers. As contaminants are captured in fuel dispensers, they are drained, through gravity or with the assistance of a pump, into the contaminant chamber of the underground storage tank. The conduit fluidly connecting the sumps to the contaminant section may be double walled piping, and there may be an oil-water separator upstream of the contaminant chamber. A sensor may be positioned in the contaminant section for indicating when a service call is needed.

Variations may be accomplished by repositioning the oil-water separator or varying the generation and reporting activity associated with an alarm. Still another embodiment partitions the underground storage tank into a low octane storage section and a high octane storage section, along with the contaminant chamber. Additionally, the underground storage tank may be positioned at various locations throughout the fueling environment, such as directly beneath a fuel dispenser.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates communication connections in an exemplary fueling environment;

FIG. 2 illustrates fluid connections in an exemplary fueling environment;

FIG. 3 illustrates a cross-sectional view of an underground storage tank and fuel dispenser according to an exemplary embodiment of the present invention;

FIG. 4 illustrates a second exemplary embodiment of an underground storage tank and fuel dispenser;

FIG. 5 illustrates a third exemplary embodiment of an underground storage tank and fuel dispenser;

FIG. 6 illustrates a fourth embodiment of an underground storage tank and fuel dispenser;

FIG. 7 illustrates a flow chart outlining the methodology of the present invention; and

FIG. 8 illustrates an alternate methodology of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

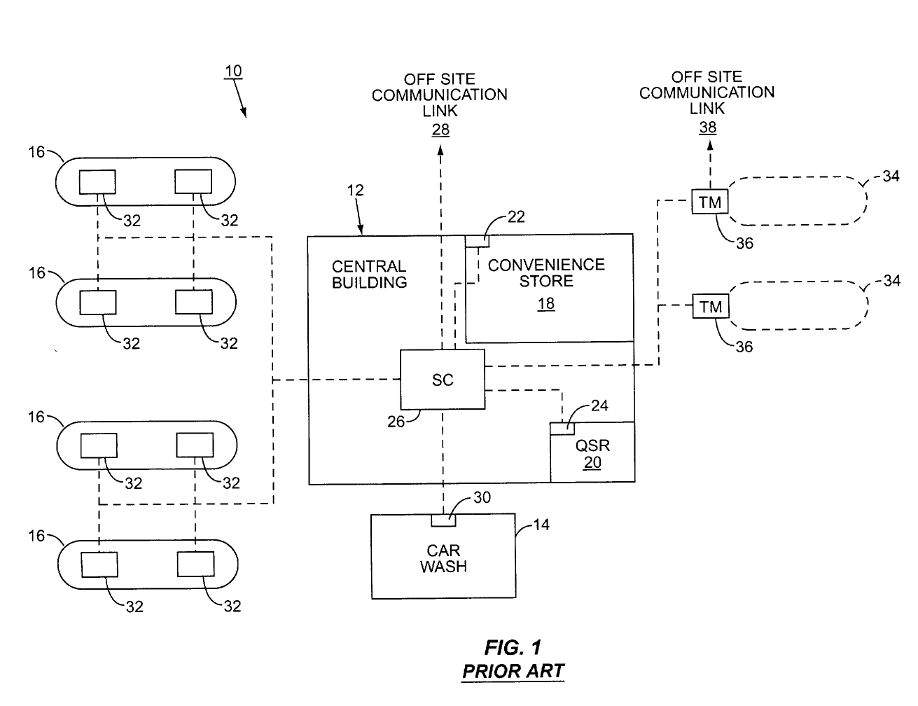

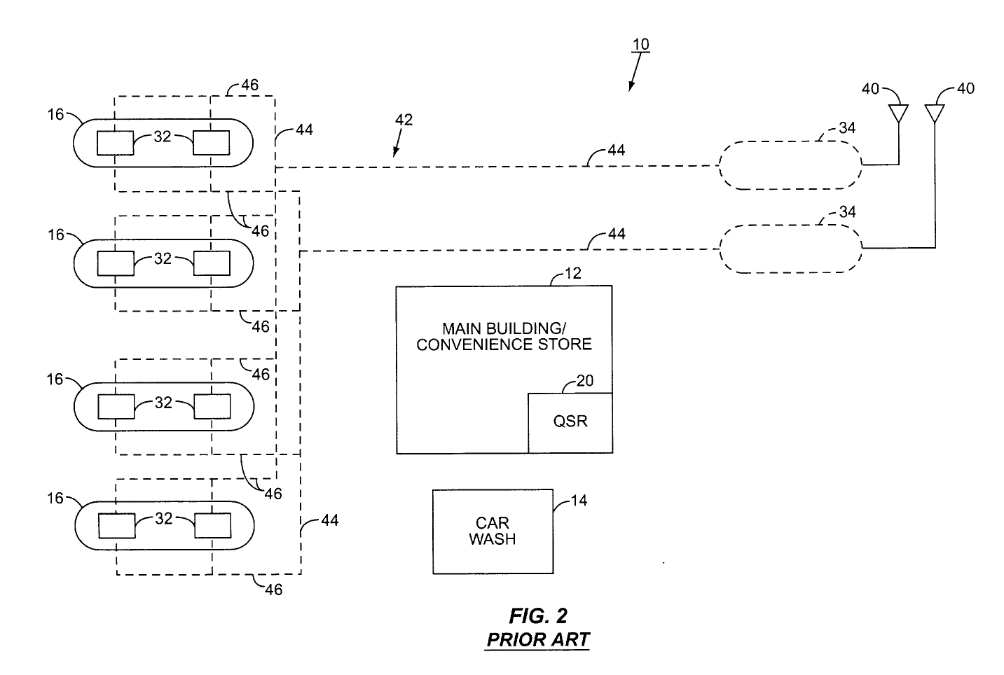

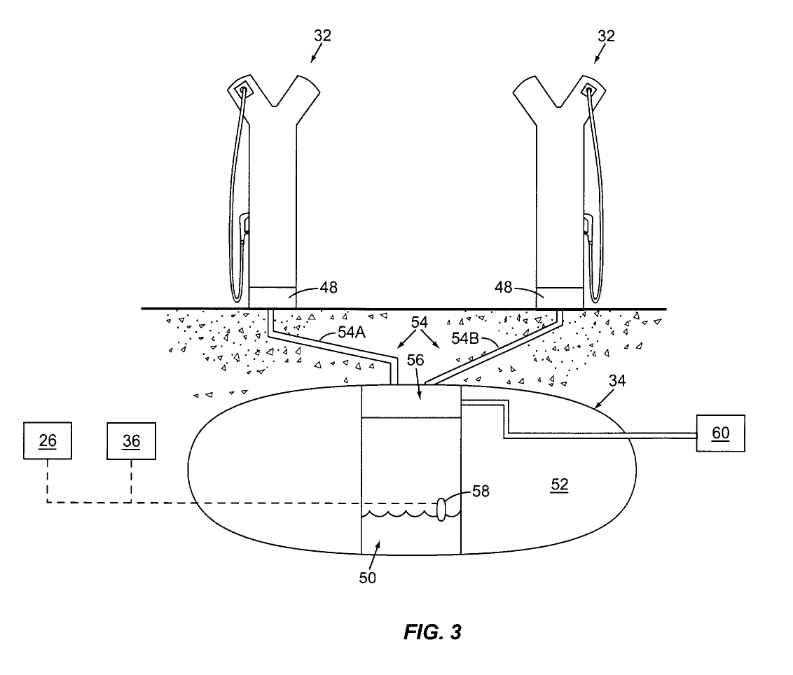

Fueling environments come in many different designs. Before describing the particular aspects of the present invention (which begins at the description of FIG. 3), a brief description of a fueling environment follows. A conventional, exemplary fueling environment 10 is illustrated in FIGS. 1 and 2. Such a fueling environment 10 may comprise a central building 12, a car wash 14, and a plurality of fueling islands 16.

The central building 12 need not be centrally located within the fueling environment 10, but rather is the focus of the fueling environment 10, and may house a convenience store 18 and/or a quick serve restaurant 20 therein. Both the convenience store 18 and the quick serve restaurant 20 may include a point of sale 22, 24, respectively. The central building 12 may further house a site controller (SC) 26, which in an exemplary embodiment may be the G-SITE® sold by Gilbarco Inc. of Greensboro, N.C. The site controller 26 may control the authorization of fueling transactions and other conventional activities as is well understood. The site controller 26 may be incorporated into a point of sale, such as point of sale 22, if needed or desired. Further, the site controller 26 may have an off site communication link 28 allowing communication with a remote location for credit/debit card authorization, content provision, reporting purposes, or the like, as needed or desired. The off site communication link 28 may be routed through the Public Switched Telephone Network (PSTN), the Internet, both, or the like, as needed or desired.

The car wash 14 may have a point of sale 30 associated therewith that communicates with the site controller 26 for inventory and/or sales purposes. The car wash 14 alternatively may be a stand alone unit. Note that the car wash 14, the convenience store 18, and the quick serve restaurant 20 are all optional and need not be present in a given fueling environment 10.

The fueling islands 16 may have one or more fuel dispensers 32 positioned thereon. The fuel dispensers 32 may be, for example, the ECLIPSE® or ENCORE® sold by Gilbarco Inc. of Greensboro, N.C. The fuel dispensers 32 are in electronic communication with the site controller 26 through a LAN or the like.

The fueling environment 10 also has one or more underground storage tanks 34 adapted to hold fuel therein. As such, the underground storage tank 34 may be a double walled tank. Further, each underground storage tank 34 may be associated with a tank monitor (TM) 36, or one tank monitor 36 may handle all the underground storage tanks 34. The tank monitors 36 typically have fluid level sensors and other data gathering devices positioned in the underground storage tanks 34 which are communicatively coupled to the tank monitor 36. In some implementations, the tank monitor 36 may be positioned in the central building 12, however, because the tank monitors 36 monitor fluid levels within the underground storage tanks 34, the tank monitors 36 are shown schematically positioned next to the underground storage tanks 34. The tank monitors 36 may communicate with the fuel dispensers 32 (either through the site controller 26 or directly, as needed or desired) to determine amounts of fuel dispensed and compare fuel dispensed to current levels of fuel within the underground storage tanks 34 as reported by the sensors to determine if the underground storage tanks 34 are leaking.

The tank monitor 36 may communicate with the site controller 26 and further may have an off site communication link 38 for leak detection reporting, inventory reporting, or the like. Much like the off site communication link 28, the off site communication link 38 may be through the PSTN, the Internet, both, or the like. If the off site communication link 28 is present, the off site communication link 38 need not be present and vice versa, although both links may be present if needed or desired. As used herein, the tank monitor 36 and the site controller 26 are site communicators to the extent that they allow off site communication and report site data to a remote location.

For further information on how elements of a fueling environment 10 may interact, reference is made to U.S. Pat. No. 5,956,259, which is hereby incorporated by reference in its entirety. Information about fuel dispensers may be found in commonly owned U.S. Pat. Nos. 5,734,851 and 6,052,629, which are hereby incorporated by reference in their entirety. Information about car washes may be found in commonly owned U.S. patent application Ser. No. ______, filed May 6, 2002, entitled IMPROVED SERVICE STATION CAR WASH, which is hereby incorporated by reference in its entirety. An exemplary tank monitor 36 is the TLS-350R manufactured and sold by Veeder-Root. For more information about tank monitors and their operation, reference is made to U.S. Pat. Nos. 5,423,457; 5,400,253; 5,319,545; and 4,977,528, which are hereby incorporated by reference in their entireties.

In addition to the various conventional communication links between the elements of the fueling environment 10, there are conventional fluid connections to distribute fuel about the fueling environment 10 as illustrated in FIG. 2. Underground storage tanks 34 may each be associated with a vent 40 that allows over-pressurized tanks to relieve pressure thereby. A pressure valve (not shown) is placed on the outlet side of each vent 40 to open to atmosphere when the underground storage tank 34 reaches a predetermined pressure threshold. Additionally, under-pressurized tanks may draw air in through the vents 40. In an exemplary embodiment, two underground storage tanks 34 exist—one a low octane tank (87) and one a high octane tank (93). Blending may be performed within the fuel dispensers 32, as is well understood, to achieve an intermediate grade of fuel. Alternatively, additional underground storage tanks 34 may be provided for diesel and/or an intermediate grade of fuel (not shown).

Pipes 42 connect the underground storage tanks 34 to the fuel dispensers 32. The pipes 42 may be arranged in a main conduit 44 and branch conduit 46 configuration, where the main conduit 44 carries the fuel from the underground storage tanks 34 to the branch conduits 46, and the branch conduits 46 connect to the fuel dispensers 32. Typically, the pipes 42 are double walled pipes comprising an inner conduit and an outer conduit. Fuel flows in the inner conduit to the fuel dispensers 32, and the outer conduit insulates the environment from leaks in the inner conduit. For a better explanation of such pipes and concerns about how they are connected, reference is made to Chapter B13 of PIPING HANDBOOK, 7^{th} edition, copyright 2000, published by McGraw-Hill, which is hereby incorporated by reference.

In a typical service station installation, leak detection may be performed by a variety of techniques, including probes and leak detection cables. More information about such devices can be found in the previously incorporated PIPING HANDBOOK. Conventional installations capture the leaked fuel in low point sumps, sumps in the fuel dispensers 32, or the like, where the fuel mixes with contaminants such as dirt, water, and the like, thereby ruining the fuel for future use without processing.

While not shown, vapor recovery systems may also be integrated into the fueling environment 10, with vapor recovered from fueling operations being returned to the underground storage tanks 34 via separate vapor recovery lines (not shown). For more information on vapor recovery systems, the interested reader is directed to U.S. Pat. Nos. 5,040,577; 6,170,539; and Re. 35,238, and U.S. patent application Ser. No. 09/783,178 filed Feb. 14, 2001, all of which are hereby incorporated by reference in their entireties.

The present invention consolidates the fluids collected in the sumps into a centralized containment vessel. To this end, as illustrated in FIGS. 3-6, a variety of configurations may be possible. In FIG. 3, the fuel dispensers 32 each include a sump 48, which captures leaking fuel and contaminants. The sumps 48 (and any other low point sumps in the piping system) drain to a contaminant chamber 50 in the underground storage tank 34 via pipes 54. The contaminant chamber 50 may be double walled so as to prevent fluid communication with the fuel storage portion 52 of the underground storage tank 34. Note that the pipes 54 may be sloped to a variety of degrees, such as gradual slope 54A to steep slope 54B, to allow gravity to drain the sumps 48 of the fuel dispensers 32. The precise slope of the pipes 54 will vary depending upon the topography of the fueling environment 10 and the respective locations of the fuel dispensers 32 and the underground storage tank 34. Likewise, the pipes 54 may be double walled, as needed or desired, to protect the environment from leaks in the pipes 54.

In this embodiment, once the contaminants have reached the contaminant chamber 50, they are passed through an oil-water separator 56, which may flush the clean, filtered water to the surrounding soil or a remote receptacle 60. While it is preferred to use an oil-water separator 56, such a device is optional and all the contaminants and water may be deposited in the contaminant chamber 50. Likewise, repositioning the oil-water separator 56 is also possible as is explained below. Exemplary oil-water separators are disclosed in U.S. Pat. Nos. 6,139,730; 5,928,524; and 4,238,333, all of which are hereby incorporated by reference in their entireties.

The remaining contaminants are deposited in the contaminant chamber 50 where they may be removed during a service call. A float sensor 58 or other sensor may be positioned in the contaminant chamber 50 to detect a level of contaminants within the contaminant chamber 50. The float sensor 58 may be communicatively coupled to the tank monitor 36 or other site communicator such as the site controller 26, as needed or desired, to report fluid levels within the contaminant chamber 50 to the station operator or a remote location. If the float sensor 58 detects a fluid level that is above a predetermined threshold, a service call may be requested. Additionally, if the float sensor 58 rises more than a predetermined amount within a predetermined time, it may be indicative of a leak in the piping system or fuel dispensers 32, and may generate a call for service to a remote location through one of the remote communication links 28, 38.

Note that for this and all the other embodiments, the contaminant chamber 50 is shown generally in the center of the underground storage tank 34. While this is a preferred arrangement, the contaminant chamber 50 may be repositioned within the underground storage tank 34 as needed or desired. For example, the contaminant chamber 50 could be positioned at one end or the other end of the underground storage tank 34 without departing from the scope of the present invention.

As an alternative to service call requests that are generated in response to levels within the contaminant chamber 50, the tank monitor 36 and/or the site controller 26 may evaluate a fill rate as determined by changes in the fluid level divided by time and make a predictive service call. For example, if the fill rate over two days is two gallons/day and the contaminant chamber 50 has a capacity of fifty gallons, then the site communicator may request a service call every twenty days and schedule such service calls ten days before the service call is needed. The difference between the capacity and the scheduled service call reflects a safety margin and may be varied depending on the desired margin. The determination of the fill rate may be an iterative determination so as to accommodate variations in fill rates experienced by the fueling environment 10.

When a service call is made in any of the above embodiments, the service personnel may trigger a button or other device so as to reset the float sensor 58 or zero out cumulative fluid levels reported and recorded in the memories of the site communicator.

For more information on correlating a liquid level sensed to volume, such as by using a look up table or formula, reference is made to U.S. Pat. No. 4,977,528, which is hereby incorporated by reference in its entirety. The '528 patent has a learning process in which it correlates sensed liquid levels to actual volumes, but other techniques are also possible if needed or desired.

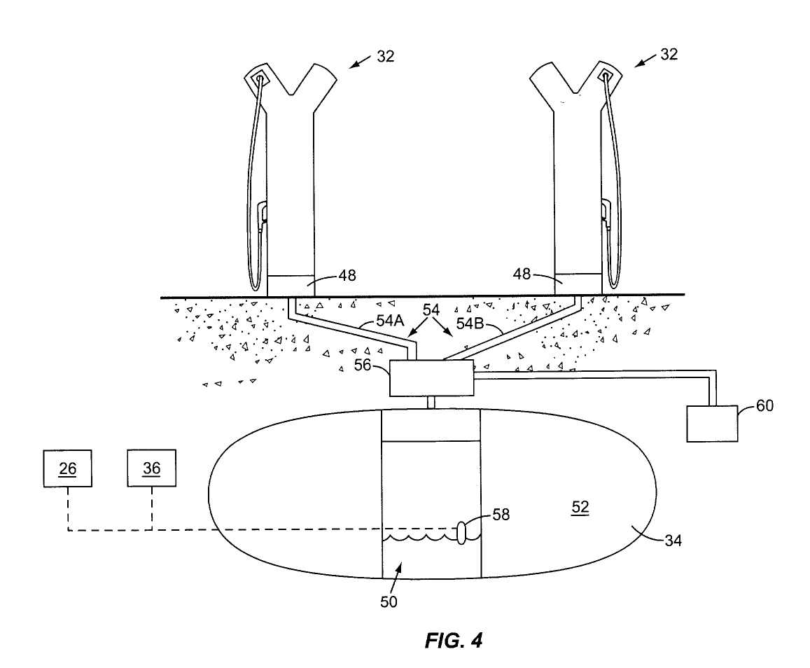

An alternate embodiment is illustrated in FIG. 4, wherein the oil-water separator 56 is positioned exteriorly of the underground storage tank 34. This may make it easier to purge filtered water to a remote receptacle 60 or other location as needed or desired. In both of these embodiments, the oil-water separator 56 is defined to be upstream of the contaminant chamber 50. Again, the contaminant chamber 50 may be double walled to isolate the contaminant chamber 50. In the situations where a remote receptacle 60 is used, service call time may be reduced because the water stored therewithin need not be collected during the service call, rather it can be discharged if the purity thereof is sufficient to meet the appropriate regulatory requirements. Separation of water before the contaminant is stored in the contaminant chamber 50 keeps the chamber 50 from filling up as fast thereby reducing the frequency of service calls required to remove the contaminant from the chamber 50.

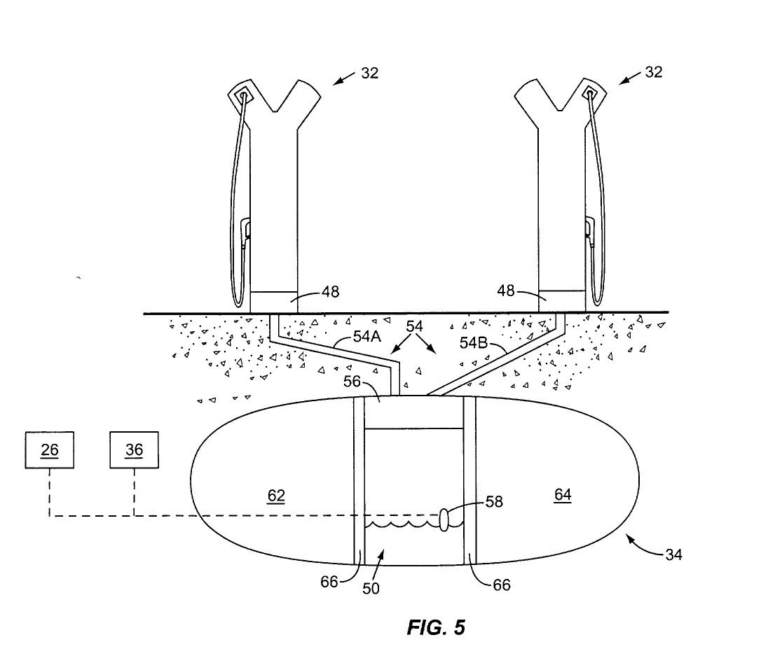

Still another alternate embodiment is illustrated in FIG. 5, wherein the underground storage tank 34 is divided into two fuel storage compartments 62, 64. The first compartment 62 may be for high-octane fuel, and the second compartment 64 may be for low octane fuel, although diesel, kerosene, or other fuel may readily be accommodated. The compartments 62, 64 may be separated from the contaminant chamber 50, and each other by a double-walled arrangement 66, as needed or desired. In this embodiment, the oil-water separator 56 may be inside or outside the underground storage tank 34 as needed or desired. Likewise, the use of the contaminant chamber 50 along with the float sensor 58 to make service calls and the like remains the same. The double chambered underground storage tank 34 provides a convenient alternative to the multi-tank arrangement in fueling environments 10 that do not have footprints large enough to accommodate multiple tanks 34. Additionally, because only one underground storage tank 34 is required, environmental containment efforts may be economized as the concrete and other safety requirements are only required for a single underground storage tank 34 instead of the previously existent two or three underground storage tanks 34.

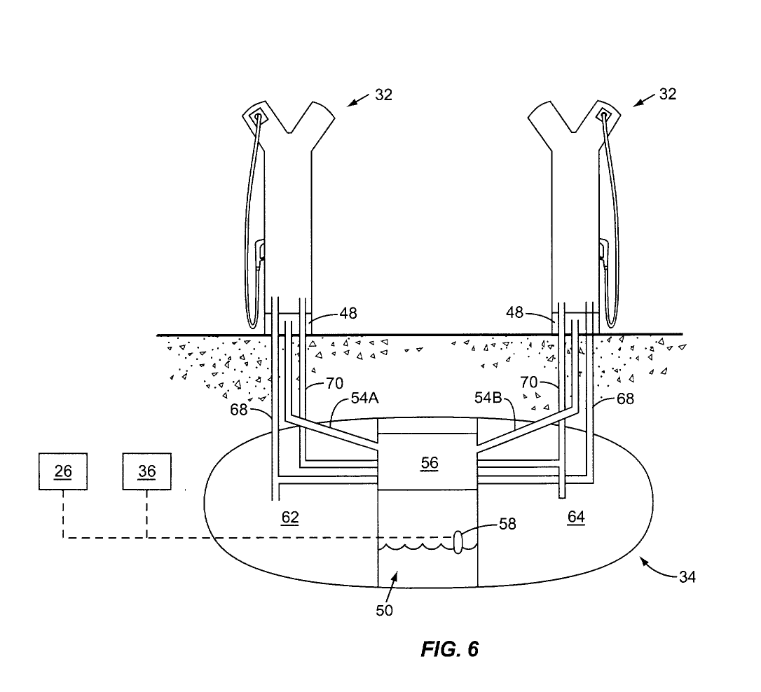

Still another embodiment is illustrated in FIG. 6, wherein the piping connecting the fuel dispensers 32 to the underground storage tank 34 and the contaminant chamber 50 is more vertically oriented, such as when the underground storage tank 34 is positioned directly beneath a fueling island 16 (FIG. 1). This embodiment is akin to the disclosures found in U.S. Pat. Nos. 5,244,307; 5,921,712; and 6,270,285, which are hereby incorporated by reference in their entireties. Specifically, this arrangement allows the footprint of the underground storage tank 34 and the excavation relating thereto to be minimized, reducing installation costs. It should be appreciated that the other embodiments of FIGS. 3-5 do not appreciably increase the footprint or the excavation requirements of a conventional fueling environment 10 as the pipes 54 used in the present invention generally duplicate the piping paths of pipes 42 already required to deliver fuel to the fuel dispensers 32.

The embodiment shown in FIG. 6 includes an oil-water separator 56 positioned interiorly of the underground storage tank 34 and a dual chambered underground storage tank 34 with high and low octane compartments 62, 64. The pipes 54 may be of any slope as previously indicated, and some or all of the slope may occur within the underground storage tank 34 if needed, depending on the placement of the contaminant chamber 50 relative to the fuel dispensers 32. A vertical fuel pipe 68 may provide the low octane fuel from the first compartment 62 to the fuel dispensers 32, and a comparable vertical fuel pipe 70 may convey the high octane fuel from the second compartment 64. While a T-intersection is shown for fuel pipes 68, 70, other arrangements may also be possible.

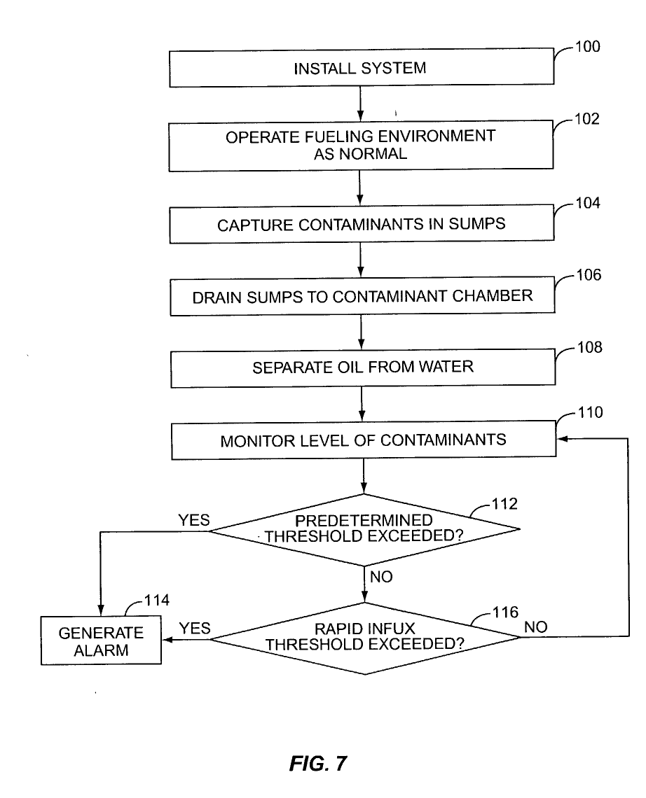

While the above explanation of the present invention supplies the outlines of the physical elements of the present invention, FIG. 7 outlines an exemplary methodology in a flow chart format. Initially, the system of the present invention is installed (block 100). This may be part of the original creation of the fueling environment 10, during a retrofit, or during a renovation process. After installation, the fueling environment 10 is operated normally (block 102). During operation, inevitably, contaminants, fuel, and the like will be generated. These are captured in the sumps 48 of the fuel dispensers 32 (block 104) or other low point sump locations throughout the piping network. As used herein, anything captured by the sumps 48 of the fuel dispensers 32 or the low point sumps of the fueling environment 10 is defined as being a contaminant.

The contents of the sumps 48 are drained by gravity or other technique to the contaminant chamber 50 (block 106). While gravity is the mode particularly contemplated, a pump (not shown), or other assistance-oriented device may be used to move the contaminants to the contaminant chamber 50. If present, the oil-water separator 56 removes water from the sump effluent (block 108), perhaps draining the water to the remote receptacle 60, and allows the remaining contaminants to enter the contaminant chamber 50 proper. The float sensor 58 monitors the level of fluid within the contaminant chamber 50 (block 110) and reports the level of material within the contaminant chamber 50 to the tank monitor 36, the site controller 26, or other location, as needed or desired.

If the tank monitor 36 or other site communicator, through the float sensor 58, determines that a predetermined threshold has been exceeded (block 112), an alarm may be generated (block 114). This predetermined threshold may be a fluid level within the contaminant chamber 50 or other criterion by which it may be determined that a service call is in order.

If however, the tank monitor 36 or other site communicator, through the float sensor 58, has not passed the predetermined threshold, the float sensor 58 may further be used to determine if a rapid influx threshold has been exceed (block 116). If not, the process repeats as normal. If, however, it is determined that the contaminant chamber 50 is rapidly filling, indicative of a leak or other serious problem, an alarm may be generated (block 114).

The alarm of block 114 may be the site communicator reporting to a remote location, alerting personnel within the fueling environment 10, or the like as needed or desired. The alarm at the remote location may generate a service call to empty to the contaminant chamber 50 or inspect the piping system or the like as needed or desired. Further, the fuel dispensing capabilities of the fueling environment 10 may optionally be suspended until a service call is made. Note that the functions of the present invention need not be as linear as indicated, and some steps may be performed concurrently or in other sequences as needed or desired.

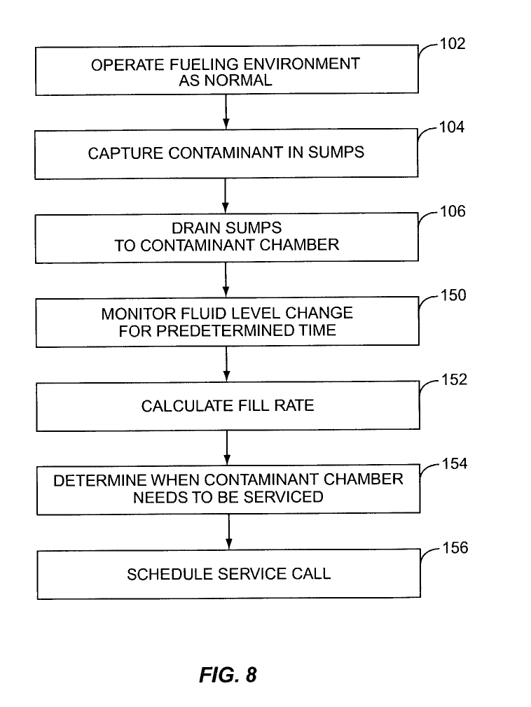

FIG. 8 illustrates the predictive service call scheduling methodology in a flow chart format. The beginning process is very similar to the process of FIG. 7, in that after installation, the fueling environment 10 is operated as normal (block 102) and contaminants are captured in the sumps 48 and other low point sumps (block 104). The sumps 48 are drained to the contaminant chamber 50 (block 106).

The tank monitor 36 or the site controller 26 evaluates the output of the float sensor 58 and monitors the fluid level change for a predetermined period of time (block 150). This may be a day, an hour, or other unit of time as needed or desired. From this, the monitoring device can calculate a fill rate for the contaminant chamber 50 (block 152). This is accomplished by dividing the volume change (as indicated by the change in fluid level) by the time unit. From the fill rate, the monitoring device can determine when the contaminant chamber 50 needs to be serviced (block 154). This may be done by dividing the volume of the contaminant chamber 50 by the fill rate. The output of this division should be expressed as a time unit, and thus, the site communicator can then use this time unit to schedule a service call (block 156). Note that it may be desirable to advance the service call by a safety margin such that the service call does not occur exactly when the contaminant chamber 50 is expected to be full, but rather it may occur a day or two before.

Note that while the flow chart of FIG. 8 is one way to schedule predictively the service calls, the fill rate calculation may be iterative or averaged over a longer period of time such that spurious variations in the fill rate do not cause a service call to be scheduled too soon or too late. Note further that this technique can be used in conjunction with the threshold determinations of FIG. 7 such that emergency service calls are still made in the event of a leak or the contaminant chamber 50 filling faster than expected.

Those skilled in the art will recognize improvements and modifications to the preferred embodiments of the present invention. All such improvements and modifications are considered within the scope of the concepts disclosed herein and the claims that follow.

What is claimed is:

1. An underground storage tank, comprising:
a fuel containment section; and
a contaminant chamber fluidly isolated from said fuel containment section and adapted to receive contaminants from fuel dispensers in a fueling environment.

2. The underground storage tank of claim 1, further comprising a sensor positioned within said contaminant chamber and adapted to report contaminant levels within said contaminant chamber to a position removed from said underground storage tank.

3. The underground storage tank of claim 1, further comprising an oil-water separator associated with said contaminant chamber.

4. The underground storage tank of claim 3, wherein said oil-water separator is positioned within said contaminant chamber.

5. The underground storage tank of claim 3, wherein said oil-water separator is positioned without said contaminant chamber.

6. The underground storage tank of claim 1, wherein said fuel containment section comprises a first chamber and a second chamber fluidly isolated from one another and adapted to hold two different types of fuel therein.

7. The underground storage tank of claim 1, wherein said underground storage tank is adapted to be positioned directly beneath a fuel dispenser.

8. The underground storage tank of claim 2, wherein said sensor comprises a float sensor.

9. The underground storage tank of claim 2, wherein said sensor is adapted to communicate to a remote location.

10. The underground storage tank of claim 9, wherein said remote location comprises a site communicator.

11. The underground storage tank of claim 2, wherein said sensor communicates fluid levels within said contaminant chamber to a remote location.

12. The underground storage tank of claim 2, wherein said sensor communicates rapid inflow conditions within said contaminant chamber to a remote location.

13. A fuel dispenser, comprising:
a sump; and
a drainage pipe draining said sump to an underground storage tank for containment of contaminants captured within the sump.

14. A fueling environment, comprising:
at least one fuel dispenser comprising a sump for capturing leaking fuel and contaminants therein;
a drainage system adapted to drain the sumps in the at least one fuel dispenser; and
an underground storage tank, comprising:
a fuel containment section; and
a contaminant chamber fluidly isolated from said fuel containment section and adapted to receive contaminants from the drainage system.

15. The fueling environment of claim 14, wherein said drainage system operates as a function of gravity.

16. The fueling environment of claim 14, further comprising an oil-water separator adapted to separate water from oil and other contaminants, said oil-water separator associated with the drainage system.

17. The fueling environment of claim 16, wherein said oil-water separator is positioned within said contaminant chamber.

18. The fueling environment of claim 16, wherein said oil-water separator is positioned without said contaminant chamber.

19. The fueling environment of claim 14, wherein said fuel containment section comprises a first chamber and a second chamber fluidly isolated from one another and adapted to hold two different types of fuel respectively.

20. The fueling environment of claim 14, wherein said underground storage tank is positioned beneath said at least one fuel dispenser and fuel is carried substantially vertically upwardly to said fuel dispenser from said fuel containment chamber.

21. A method of handling contaminants in a fueling environment, comprising:
collecting contaminants in a fuel dispenser sump; and
draining the fuel dispenser sump to a contaminant chamber within an underground storage tank.

22. The method of claim 21, further comprising sensing contaminant levels within said contaminant chamber.

23. The method of claim 22, further comprising reporting said contaminant levels to a remote location.

24. The method of claim 21, further comprising sensing rapid influx conditions.

25. The method of claim 21, further comprising collecting said contaminants from low point sumps in a piping network to said contaminant chamber.

26. The method of claim 23, wherein reporting said contaminant levels to said remote location comprises requesting a service call.

27. The method of claim 23, wherein reporting said contaminant levels to said remote location comprises reporting to a tank monitor.

28. The method of claim 21, further comprising positioning said underground storage tank directly beneath at least one fuel dispenser.

29. The method of claim 21, further comprising utilizing an oil-water separator on said contaminants drained from said fuel dispenser sump.

30. The method of claim 29, wherein utilizing said oil-water separator comprises using said oil-water separator positioned outside said contaminant chamber.

31. The method of claim 29, wherein utilizing said oil-water separator comprises using said oil-water separator positioned inside said contaminant chamber.

32. The method of claim 21, further comprising dispensing two types of fuel from the underground storage tank.

33. The method of claim 23, wherein reporting said contaminant levels to said remote location comprises predictively requesting a service call.
